(19) United States
(12) Patent Application Publication
(10) Pub. No.: US 2021/0272382 A1
(43) Pub. Date: Sep. 2, 2021

(54) AUTOMATED PARKING TRACKER

(71) Applicant: Micron Technology, Inc., Boise, ID (US)

(72) Inventor: Robert Richard Noel Bielby, Placerville, CA (US)

(21) Appl. No.: 16/805,596

(22) Filed: Feb. 28, 2020

(51) Int. Cl. G07B 15/02; G06Q 20/08; G06K 9/00; G08G 1/14

(52) U.S. Cl. CPC G07B 15/02; G06Q 20/085; G06F 16/22; G08G 1/149; G06Q 2240/00; G06K 9/00771

(57) ABSTRACT

The present disclosure is directed to managing and enforcing vehicle parking. A system may receive at least one parking message from a sensor. The parking message may indicate whether a vehicle is in the parking spot and then track a duration that the vehicle is in the parking spot based on the at least one parking message. Some embodiments involve initiating a timer in response to receiving a parking request, wherein a timer expiration is set according to a requested parking duration. In addition, a first alarm signal may be generated in response to the duration exceeding a predetermined threshold and in response to not receiving a parking request; and a second alarm signal may be generated in response to an indication that the vehicle is in the parking spot and in response to the timer expiring.

### BACKGROUND

Parking meters, kiosks, parking enforcement officers, and parking lot attendees may regulate vehicles that park in parking spots. A vehicle owner may manually submit a payment to a machine, device, or person to pay for parking in a spot for a particular duration. However, some vehicle owners may park illegally, not make payments, or stay past a prepaid duration of time.

Parking monitoring mechanisms may involve individuals to police parking violations, check parking meters, track vehicles, and issue citations when a vehicle is illegally parked. Individuals may use chalk to mark a vehicle for tracking their parking duration. Alternatively, some parking meters must manually be checked to see if a parking violation occurs.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of a networked environment according to various embodiments of the present disclosure.

FIG. 2 is a drawing of various components relating to a parking meter that may be implemented in the networked environment of FIG. 1 according to various embodiments of the present disclosure.

FIGS. 3A-3D depict various timing diagrams showing functionality or operations that may occur in the networked environment of FIG. 1 according to various embodiments of the present disclosure.

FIG. 4 is a flowchart illustrating an example of the functionality implemented in the networked environment of FIG. 1 according to various embodiments of the present disclosure.

FIG. 5 is a schematic block diagram that provides one example of a computing device used to implement various embodiments of the present disclosure.

### DETAILED DESCRIPTION

Various embodiments of the present disclosure relate to the use of sensors to regulate and manage vehicle parking. A sensor may be configured to sense a vehicle in a parking spot. It may be installed, for example, in the ground or above the parking spot. A duration that the vehicle has been parked may be calculated based on sensor data. The identity of the vehicle may be determined and transmitted to the sensor or other networked device to obtain permission for parking.

In some embodiments, a camera may be used to read the license plates of a parked vehicle. The camera may be installed at fixed locations, or carried by a patrol vehicle. The patrol vehicle may be an autonomous vehicle, robot, drone, or manually driven vehicle. Vehicle owners may register their contact information for notifications and/or payment methods for parking fees. Notifications may be transmitted to the owners/drivers according to the registered contact information. Through the use of notifications, vehicle owners may obtain parking validation from business establishments.

Vehicle owners may pay any parking fees via a centralized portal by looking up the parked vehicle by license plate number. Unpaid parking fees and/or tickets may be billed to registered addresses of the vehicle. While the foregoing provides a high level summary, the details of the various embodiments may be understood with respect to the figures.

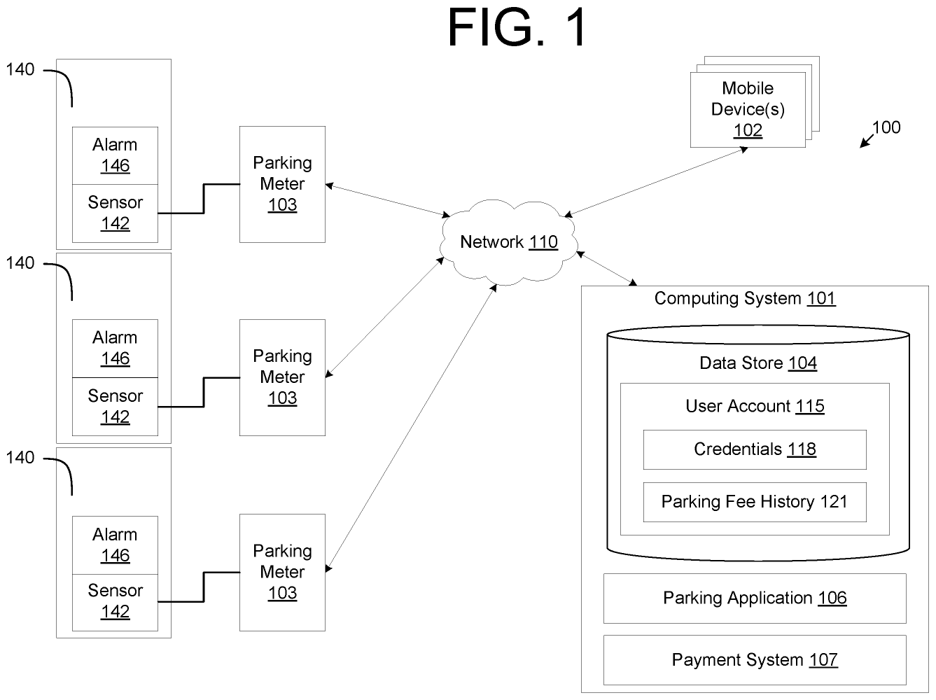

FIG. 1 shows a networked environment 100 according to various embodiments. The networked environment 100 includes a computing system 101 comprising a combination of hardware and software. It further includes mobile devices 102 and may include parking meters 103.

The computing system 101 includes a data store 104, a parking application 106, and payment system 107. The computing system 101 may be connected to a network 110 such as the Internet, intranets, extranets, wide area networks (WANs), local area networks (LANs), wired networks, wireless networks, or other suitable networks, etc., or any combination of two or more such networks. The network 110 may also comprise a peer-to-peer contention or shortrange wireless connection.

The computing system 101 may comprise, for example, a server computer or any other system providing computing capability. Alternatively, the computing system 101 may employ a plurality of computing devices that may be arranged, for example, in one or more server banks or computer banks or other arrangements. Such computing devices may be located in a single installation or may be distributed among many different geographical locations. For example, the computing system 101 may include a plurality of computing devices that together may comprise a hosted computing resource, a grid computing resource and/or any other distributed computing arrangement. In some cases, the computing system 101 may correspond to an elastic computing resource where the allotted capacity of processing, network, storage, or other computing-related resources may vary over time. The computing system 101 may implement one or more virtual machines that use the resources of the computing system 101.

Various applications and/or other functionality may be executed in the computing system 101 according to various embodiments. Also, various data is stored in the data store 104 or other memory that is accessible to the computing system 101. The data store 104 may represent one or more data stores 104. This data includes, for example, user accounts 115. A user account 115 includes a user's credentials 118 which may be, for example, a user name, password, identification of the user's mobile device 102, and other information use to authenticate a user. The user account 115 may also include the user's contact information such as, for example, email address, phone number, and mailing address. The user account 115 may include one or more vehicle identifiers of vehicles registered to the user. A vehicle identifier may be, for example, a license plate number. The user account 115 may include parking fee history 121 associated with the user account 115. Parking fee history 121, may include, for example, an outstanding balance of parking fees owed by the user or parking fees that are currently being accrued.

As mentioned above, the components executed on the computing system 101 may include the parking application 106 and payment system 107, which may access the contents of the data store 104. The parking application 106 provides a centralized application to monitor and regulate parking. The parking application 106 may interface with mobile devices 102 by providing a portal to register a user account 115, obtain user account information, track parking activity, handle billing, and facilitating transactions to pay accrued parking fees. The parking application 106 may also interface with one or more parking meters 103 to obtain localized parking information.

The payment system 107 may be configured to receive and process financial transactions. The payment system 107 may receive cash, coins, or information about a financial instrument (e.g., credit card, debit card, etc.) and then facilitate the processing of a transaction involving the financial instrument. The payment system 107 and parking application 106 may communicate with one another through, for example, one or more application program interfaces (APIs).

The networked environment 100 also includes one or more mobile device(s) 102. A mobile device 102 allows a user to interact with the components of the computing system 101 over a network 110. A mobile device 102 may be, for example, a cell phone, laptop, or any other computing device used by a user.

When used by a vehicle owner who wishes to park, the mobile device 102 may include an application that communicates with the parking application 106 or directly with a parking meter 103 to obtain authorization to park a vehicle, submit a parking request, pay parking fees, extend parking durations, obtain parking validation, and perform other operations associated with parking a vehicle.

The mobile device 102 may also be operated by a parking attendant to regulate parking. The parking attendant may use the mobile device 102 to take pictures of vehicles, obtain vehicle identifier information, and issue parking citations.

Also included in the networked environment 110 are one or more parking meters 103. A parking meter 103 may be a networked device installed near one or more parking spots. 140. The parking meter 103 may be implemented as a fixed installation that communicates over the network 110 with mobile devices 102 and/or the parking application 106. The parking meter 103 may comprise an input system such as for example, a touch screen, keypad, one or more buttons. The parking meter 103 may also comprise an output system such as, for example, a display, light emitting devices, a speaker, etc. The parking meter 103 may comprise a point-of-sale device to receive payment, receive parking requests, and issue notifications. It may also communicate with a payment system 107 to process payments.

A parking spot 140 may be delineated by markings on the ground indicating a spatial region to park a vehicle. The parking spot 140 may include a sensor 142. The sensor 142 may be installed in the ground within or proximate to a boundary defined by the parking spot 142 so as to detect vehicles that park at least partially within the parking spot 140. The sensor 142 may be installed over the parking spot 140 such that it is affixed to an overhead structure. The sensor 142 may be a motion sensor, a proximity sensor, a weight sensor, or other sensor configured to detect the presence of an object or vehicle. The sensor 142 may be configured to communicate with a parking meter 103. The sensor 142 may communicate with the parking meter 103 over the network 110, through a dedicated wire, through a peer-to-peer wireless connection, or through any other data connection.

An alarm system 146 may also be installed near or at a parking spot 140. The alarm system 146 may be in communication with a parking meter 103. The alarm system 146 may include a speaker for playing an audio alarm and/or a lighting device for presenting a light-based, visual alarm. An alarm system 146 may receive an alarm signal to sound, play, or present an alarm. The alarm signal may be generated by a parking meter 103 and transmitted to the alarm system 146.

While FIG. 1 shows a single sensor 142, a single alarm system 146, and single parking meter 103 per parking spot 140, in some embodiments, the present disclosure is directed to alternative arrangements. For example, a single sensor 142 may be configured to detect the presence of vehicles occupying different parking spots 140. A parking meter 103 may be configured to communicate with one or more sensors 142 so that it services multiple parking spots 140. For example, a parking meter 103 may serve as a hub for a plurality of parking spots 140 such that multiple sensors 142 are in communication with the parking meter 103.

Furthermore, the functionality described with respect to components such as the sensor 142, parking meter 103 and computing system 101 may be distributed or otherwise implemented in fewer systems or more systems. For example, some of the functionality described with respect to the parking meter 103 may be implemented in the sensor and/or computing system 101. For example, the sensor 142 may comprise a sensor system that directly communicates with the computing system 101 over the network 110 without use of the parking meter 103. As another example, at least some of the functionality described with respect to the computing system 101 may be distributed to the parking meter 103. The parking meter 103 may be optional such that the functionality described herein may be implemented in other devices such as, for example, the computing system 101. The parking meter 103 may also be a virtual component such that it is embodied as software and executes in the computing system 101.

Various components within the networked environment may communicate with each other using various communication protocols and other communication signaling techniques. Information such as control information or data may be embodied as signals that are transmitted between components. For example, requests, messages, alerts, notification, events, instructions, and other information may be formatted as signals that are transmitted over wired and/or wireless connections between connected components.

Next, a general description of the operation of the various components of the networked environment 100 is provided. A vehicle may be parked in a parking spot 140. Upon parking, a sensor 142 associated with the parking spot 140 begins to detect that a vehicle has been parked. The sensor 142 sends one or more parking messages to the parking meter 103. A parking message may be periodically sent to the parking meter 103. In some embodiments, the parking message is a binary indication of whether a vehicle is parked. The parking message may include an identifier that reflects the identity of the parking spot or the identity of the sensor 142. The parking message may be sent once a second, once a minute, or any other time interval. In some embodiments, the parking message includes information indicating how long the sensor has detected a parked vehicle. In some embodiments, the parking message is sent only if a parked vehicle is detected. The parking meter 103 may process a parking message to determine that a vehicle has parked depending on whether a parking message was received or depending on the contents of the parking message.

Upon receiving one or more parking messages, the parking meter 103 waits for receipt of a parking request. A parking request may be a request submitted by a user (e.g., driver, owner of the vehicle, passenger of the vehicle) of the parked vehicle for seeking permission or authorization to park. The parking request may be received via manual input at a terminal of the parking meter 103. The parking request may be received by a mobile device 102 that establishes communication with the parking meter 103. For example, the mobile device 102 may communicate with the parking meter 103 over the network 110. In other embodiments, the mobile device 102 may communicate with the parking meter 103 through the computing system 101. The parking request may be made based on establishing a peer-to-peer connection with the parking meter 103 (e.g., a Bluetooth connection) of through a portal, website, or server side application.

The parking request may include the vehicle identifier to identify the vehicle. The parking request may include a desired duration of time to park. A parking fee that correlates to the desired duration of time to park may be assessed. The parking request may comprise a method of payment or authorization to pay an assessed parking fee.

In some embodiments, if the sensor 142 detects the presence of a vehicle in the parking spot 140 and no parking request is received within a predefined period of time, then an alarm signal may be generated. The alarm signal may be transmitted to the alarm system 146 to initiate an alarm. In this respect, the predefined period of time may be considered as a grace period to allow a user to submit a parking request after parking the vehicle.

In some embodiments, the parking request is automatically generated in response to the vehicle parking in the parking spot 140. In other words, the parking request is passive such that the request is implicitly made based on the vehicle's actions. In response, The system automatically may automatically identity of the vehicle and its status as a parked vehicle and then check against one or more parking rules. For example, a rule may be free parking for one hour. Another rule may be free parking for up to one hour but no multiple one-hour parking in a same day. Some rules may prohibit multiple one-hour parking within a given zone (e.g., a driver is not allowed to park the vehicle in one spot for one-hour and move to the next spot in the same zone for another hour on a same day). Some parking rules may or may not require a fee.

In some embodiments, a plurality of alarm signals are generated, each reflecting an increasingly severe alarm as the grace period proceeds to expire. For example, the alarm system 146 may change colors indicating that the grace period is approaching expiration. A first color or animation (e.g., solid yellow) may be presented by the alarm system 146 when a sensor detects a parked vehicle. A second color or animation (e.g., flashing yellow or flashing red) may be presented by the alarm system 146 as the grace period is partially expired. A third color or animation, (e.g., flashing yellow or solid red) may be presented by the alarm system 146 as the grace period is on the verge of expiring. And an audible alarm may be played by the alarm system 146 upon the grace period expiring. Thus, the use of a sensor 142 and a grace period incentivize a vehicle owner to provide a parking request soon after the vehicle is parked. This may discourage people to park in parking spots 140 without submitting a parking request and paying parking fees.

Some embodiments of the present disclosure are directed to obtaining the vehicle identity to help regulate parking. A camera may be used to read the license plates of a parked vehicle. The camera may be installed at fixed locations such as, for example, near a parking spot 140, at the parking meter 104, at the sensor 142, or at other locations where a vehicle may pass. Cameras may also be used a patrol vehicle. The patrol vehicle may be an autonomous vehicle, robot, drone, or manually driven vehicle. Upon capturing an image of the vehicle, the license plate number may be extracted or derived using optical pattern recognition software. The license plate number may be provided to the parking meter 103 as the parking meter tracks 103 which parking spots 140 contain parked vehicles.

As mentioned above, after a user parks, a user may provide a parking request. Receipt of the parking request initiates a parking timer. The duration of the parking timer may be set to a desired parking duration specified by the user that submitted the parking request. The initialization of the parking timer may be contingent upon receipt of payment from the user after the user submits a parking request. For example, after the parking meter 103 assesses a parking fee, the user may submit a payment at a terminal of the parking meter 103 or through a mobile device 102 that is connected over the network 110. Received payment may be transmitted to the computing system 101 and processed by a payment system 107. The parking meter 103 may alternatively comprise at least a portion of the payment system 107 to facilitate a financial transaction. Upon successfully processing the payment, the timer may initialize and begin counting down according to a specified duration.

The parking meter 103 continues to monitor the timer while the sensor 142 indicates that the vehicle is parked. If the sensor 140 indicates that the vehicle is no longer parked such that the parking spot 140 is empty, then the timer may end and the parking meter waits for another vehicle to park in the parking spot 140. If the timer expires while the vehicle remains parked in the parking spot, then the parking meter 103 may generate an alarm signal to cause the alarm system 146 to present an alarm. The parking meter 103 may work in conjunction with a parking application 106 to update a parking fee history 121 associated with the parked vehicle. The parking application 106 may generate a parking fee for exceeding the parking duration.

In some embodiments, users may register their contact information for notifications and/or payment methods for parking fees. Through a mobile device 102, a user may register himself or herself through a portal provided by the parking application 106. The user may create a user account 115 and provide user account information such as, for example, a license plate number, contact information, and/or methods of payment. The user may view a cumulative parking fee balance stored as part of a parking fee history 121 in the user's account. The user may submit a parking fee payment to be applied towards the cumulative parking fee balance.

In some embodiments, a user may obtain parking validation at business locations near the parking spot. A parking validation may be inputted into a mobile device 102. For example, the mobile device 102 may scan a QR code, take a picture and process a visual identifier of the parking validation, or otherwise receive information about the parking validation via an input mechanism of the mobile device 102. In response, the parking validation may extend or update a running parking timer, offset a payment owed, or issue a parking fee refund.

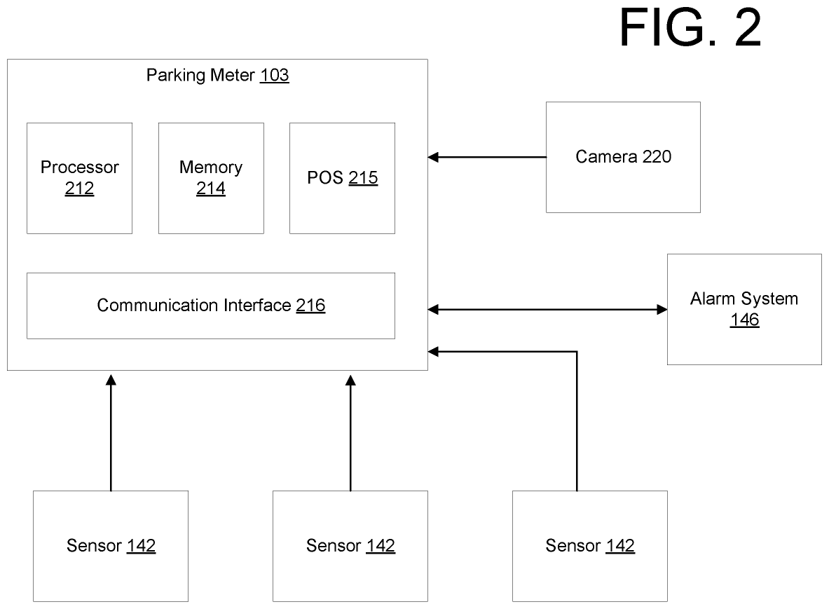

FIG. 2 is a drawing of various components relating to a parking meter 103 that may be implemented in the networked environment of FIG. 1 according to various embodiments of the present disclosure. FIG. 2 depicts a parking meter 103. The parking meter 103 may establish communication with one or more sensors 142 or may be dedicated to one sensor 142. The parking meter 103 may be coupled to an alarm system 146. The alarm system 146 may be included in the parking meter 103 or operate as a peripheral system.

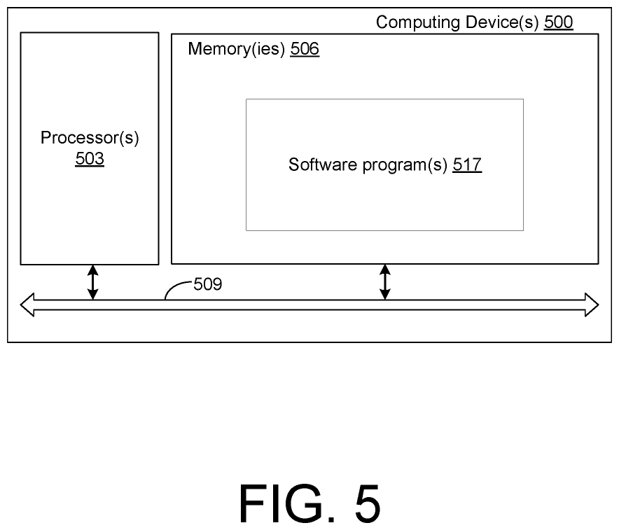

A parking meter 103 may include a processor 212, a memory 214, a point-of-sale (POS) module 215, and a communication interface 216. These components are described in greater detail with respect to FIG. 5. The parking meter 103 may also receive input from a camera 220. In some embodiments, the camera may be attached to the parking meter or positioned to capture license plate numbers from parked vehicles.

The components and functionality of the parking meter may be distributed to the sensor or computing system 101. In other embodiments, functionality associated with the computing system 101 may be implemented in the parking meter 103.

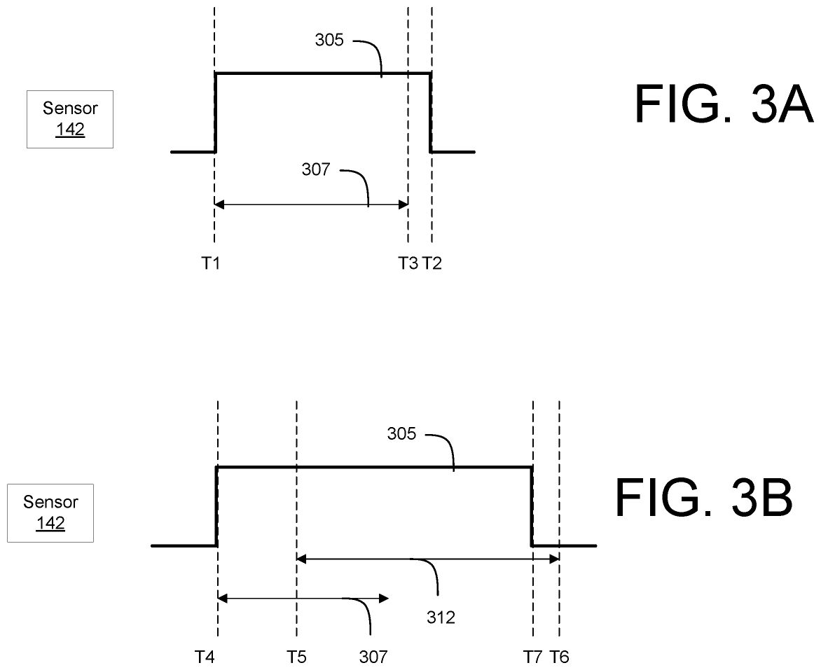

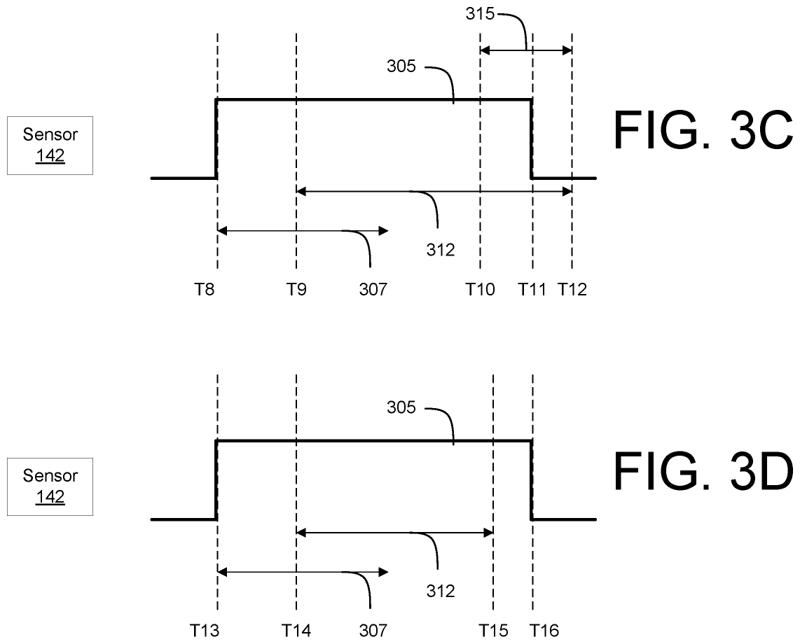

FIGS. 3A-3D depict various timing diagrams showing functionality or operations that may occur in the networked environment 100 of FIG. 1 according to various embodiments of the present disclosure. FIG. 3A shows parking data 305 corresponding to one or more parking messages generated by a sensor 142. In this example, the parking message contains a binary parameter indicating whether a vehicle is sensed in the parking spot 140. When the signal is high, a vehicle is parked in the parking spot 140. When it is low, the parking spot is empty. Although FIG. 3A shows a continuous signal, the parking messages may comprise a series of samples, each sample indicating whether a vehicle occupies a parking spot 140.

For example, if the sample rate is one minute, an individual parking message may be a sample comprising a binary value indicating whether the vehicle occupies a parking spot 140. In other embodiments, the parking message may be a raw sensor signal of sensed data to be interpreted by the parking meter 103. In other embodiments, the parking message contains a calculated duration of time that a vehicle has been parked. In this respect, the parking message may be a report that is continuously or periodically sent to the parking meter 103.

As shown in FIG. 3A, at time 1 (T1) the parking data 305 indicates that a parking spot 140 contains a newly parked vehicle. At time 2 (T2), the parking data 305 indicates that the parking spot 140 does not contain a parked vehicle. Thus, it can be inferred from the parking data 305 that a vehicle parked in the parking spot 140 at T1 and then left the parking spot 140 at T2.

In some embodiments, a grace period 307 is applied to permit a user to submit a parking request. The grace period 307 may begin at the time when a vehicle parks, such as at T1. For example, the parking meter 103 may begin a timer when the vehicle parks T1 to determine when the grace period 307 ends. In some embodiments, an alarm signal is generated when the grace period ends. This occurs at time 3 (T3). One purpose of the grace period is to give a driver enough time to submit a park request while still enforcing prompt payment of parking fees. As shown in FIG. 3A, the vehicle has parked beyond the grace period 307, which may trigger an alarm system 146 to present an alarm.

Also, in the example of FIG. 3A, an alarm being triggered at T3 may have incentivized a driver to leave the parking spot at T2 to allow other paying users to park in the parking spot 140.

FIG. 3B shows an example of a user who parks, submits a timely parking request and leaves before the parking timer expires. For example, at time 4 (T4) the user has parked in the parking spot 140. Upon the sensor 142 sensing a parked car, a grace period 307 is applied to incentivize the user to submit a parking request. At time 5 (T5), the user submits a parking request. Because this is submitted during the grace period 307 and before it expires, the system does not generate an alarm signal. At T5, the parking meter 103 initiates a parking timer in response to receiving a parking request. The parking request may include a requested parking duration 312. The timer expiration may be set according to the requested parking duration 312. For example, the user may specify a parking duration 312 of one hour. As shown in FIG. 3B, the parking duration 312 expires at time 6 (T6). The user moved the vehicle at time 7 (T7) before the timer expired, thereby avoiding an alarm in this example.

In some embodiments, when the vehicle leaves the parking spot 140, the parking meter 103 resets the timer and waits for the parking spot 140 to become occupied again. This may allow a new vehicle to not use the timer from a previous vehicle that parked in the spot.

In some embodiments, a fee is not assessed until the parking meter 103 detects that a vehicle has left the parking spot. For example, a user may park in a spot, and upon moving the vehicle, the parking meter 103 determines the duration that a vehicle has parked in the spot based on the sensor data. The parking meter 103 may calculate a parking fee an automatically bill the user by updating the user's parking fee history 121. In this embodiment, the user is not required to submit a parking request or request a parking duration.

FIG. 3C shows an example of a user who parks, submits a timely parking request and receives a notification for a parking timer that is soon to expire. At time 8 (T8), a sensor 142 detects that a vehicle has parked in a parking spot 140. A grace period 307 is applied and before the grace period expires, the user submits a parking request at time 9 (T9). The parking request includes a requested parking duration 312.

At time 10 (T10), the system generates a notification that the parking timer will expire soon. The notification is transmitted according to contact information associated with the user such that it is transmitted at predetermined time 315 prior to the timer expiring. In other words, the system subtracts a predetermined time 315 from the timer expiration to determine when to send the notification. Thus, the notification provides a warning that the timer is to expire soon.

The notification may be transmitted as an email, push notification, text message, or other electronic communication. The notification may be received by the mobile device 102 of the user. In response to receiving the notification, the user may extend the duration of timer or move the vehicle prior to the timer expiration. To extend the duration, the user may provide a second parking request to update the duration the user wishes to park the vehicle.

In the example of FIG. 3C, the user receives the notification near T10 and moves the vehicle out of the parking spot 140 at time 11 (T11) before the timer expires at time 12 (T12). Thus, in this example, the notification serves the purpose of incentivizing the user to move the vehicle.

FIG. 3D shows an example of a user who parks, submits a timely parking request but leaves after the parking timer expires, thereby violating the parking duration. For example, at time 13 (T13) the user has parked in the parking spot 140. Upon the sensor 142 sensing a parked car, a grace period 307 is applied to require the user to submit a parking request. At time 14 (T14), the user submits a parking request before the grace period expires. At T14, the parking meter 103 initiates a timer in response to receiving a parking request. The timer is configured to count down according to the duration 312 that is specified in the parking request. As shown in FIG. 3D, the parking duration 312 expires at time 15 (T15).

At T15, the parking meter 103 receives an indication that the parking timer has expired and also determines that the sensor continues to detect a parked vehicle. Based on these conditions, the parking meter 103 generates an alarm signal. An alarm system 146 is configured to receive the alarm signal and generate an alarm accordingly. The alarm may notify parking administrators to issue a parking ticket or citation.

In some embodiments, the parking meter 103 generates a parking fee and updates the parking fee history 121 to reflect the parking fee for a parking violation. In other embodiments, a parking fee violation may be automatically processed through the payment system 107 at T15. A notification may be sent to the user according to contact information that the timer expired. The notification may include an option to extend the timer.

In some embodiments, parking fees may continue to accrue after T15 until the timer is extended or until the sensor 142 detects that the vehicle is no longer in the parking spot 140. At time 16 (T16), the vehicle leaves the parking spot.

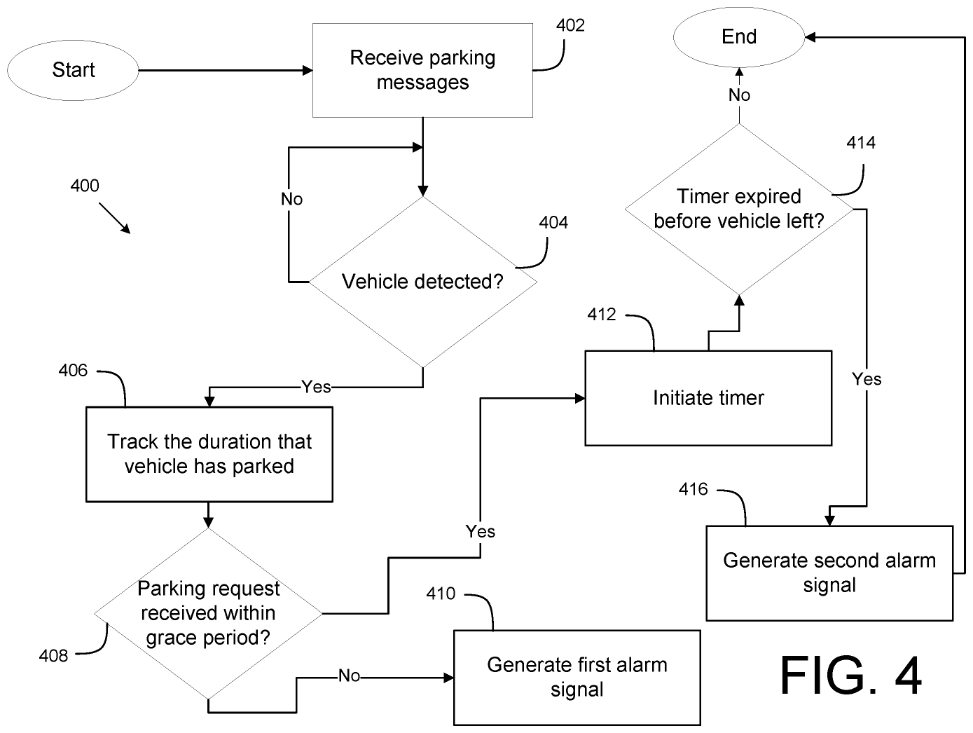

FIG. 4 is a flowchart illustrating an example of the functionality of the parking meter 103, the computing system 101, or a combination thereof as they are implemented in a networked environment 100 of FIG. 1 according to various embodiments of the present disclosure. It is understood that the flowchart of FIG. 4 provides merely an example of the many different types of functional arrangements that may be employed to implement the operation of the parking meter 103 and/or computing system 101 as described herein. The flowchart of FIG. 4 may be viewed as depicting an example of elements of a method 400 implemented by the parking meter 103 and/or computing system 101 according to one or more embodiments.

At item 402, the system receives one or more parking messages. A parking message is generated by a sensor 142. It indicates the presence of a vehicle in a particular parking spot 140. The parking message may include a sensor identifier or vehicle identifier. For example, the sensor may be configured to detect the identity of the vehicle using a camera. In some embodiments, a vehicle may be installed with an RFID tag or other near-field communication device, to allow parking sensors to identify the vehicle. The sensor may also receive the vehicle's identity from an external system such as, for example, a camera 200. A camera may be configured to capture a license plate number to identify the vehicle. Parking messages may be received periodically such that they indicate whether a vehicle is proximate to the sensor 142.

At item 404, the system waits until the parking messages indicate that a vehicle is detected or as parked in the parking spot 140. At item 406, once a vehicle has parked, the system determines that the vehicle has parked. The system may initiate a timer to track this parking duration. Thereafter, the system waits for a parking request to be received.

As explained above, the system may receive a vehicle identifier associated with the vehicle. If the vehicle identifier is not received directly from the sensor 140, it may be received from other sources. For example, a camera may be installed near the parking spot 140. The camera 220 may also be attached to a patrol vehicle. The camera 220 may be configured to capture an image of a license plate of the vehicle. The vehicle identifier may be derived from the image of the license plate using, for example, optical character recognition. In some embodiments, the vehicle identifier may be received from a mobile device 102. A mobile device 102 may connect with the system over a network 110 and submit a vehicle identifier as part of the parking request.

At item 408, if a parking request is not received within a grace period, then, at item 410, the system may generate a first alarm signal. The first alarm signal may be transmitted to an alarm system 146 to generate an audio or visual alarm. The grace period is a predetermined window of time that allows a user to submit a parking request.

If a parking request is received within the grace period, then at item 412, the system may initiate a timer. The timer may be in response to receiving a parking request that includes a requested parking duration. The timer expiration may be set according to the requested parking duration. Thus, the timer may be a countdown timer having a duration equal to the requested parking duration.

At item 414, the system checks if the timer expired before the vehicle left. If the vehicle has left the parking spot such that the sensor 142 does not detect the presence of the vehicle in the parking spot 140, then the process of FIG. 4 may end. In some embodiments, the timer is cancelled or otherwise disregarded. The system may then wait for a new vehicle to park in the parking spot 140, where it would then iterate through the flowchart of FIG. 4.

If the timer expires while the vehicle is still detected to be parked in the parking spot, then at 416, the system may generate a second alarm signal. In other words, the second alarm signal is generated in response to an indication that the vehicle is in the parking spot and in response to the timer expiring. An alarm system 146 may generate an audio or visual alarm in response to receiving the second alarm signal. In some embodiments, the alarm signal includes a vehicle identifier. In this example, the alarm signal may be sent to other devices to generate notifications or alerts using the vehicle identifier or ascertaining a user associated with the vehicle identifier.

The flowchart of FIG. 4 may be implement by a system such as a parking meter 103, a computing system 101, or a combination of the two. The system is configured to establish communication with one or more sensors 142 to carry out the operations discussed above.

In some embodiments, a user may register with the system before parking. For example, the system may register a user by obtaining a license plate number corresponding to the vehicle and the contact information associated with the user. The system may create and manage a user account 115 for the user. The user account 115 may store a cumulative parking fee balance associated with the user. The system may also receive a parking fee payment to be applied towards the cumulative parking fee balance.

In some embodiments, the system is configured to generate and transmit an electronic message instead of generating an alarm signal. In some embodiments, an electronic message is transmitting in addition to generating an alarm signal. The electronic message may be, for example, a message transmitted to the mobile device 102 of a parking attendant or to a patrol vehicle. The electronic message may indicate that a grace period has expired or that a timer has expired. The recipient of the electronic message may then take action such as, for example, issuing a parking ticket or citation.

In some embodiments, the parking request does not contain a requested parking duration. Instead, the system may apply one or more parking rules to assess parking fees. For example, the parking meter 103 may assess the fee after the vehicle has moved based on the sensor data. Another example of a rule may be that vehicles may be parked in a spot for a fixed parking fee up to a certain time of day. For example, the parking meter 103 may implement all day parking for $20.00 up until 10:00 PM. In this case, a user may park as long as he or she wishes as long as it does not exceed 10:00 PM. In this case, an additional parking violation may be assessed if the vehicle is detected to be parked past 10:00 PM. Another example of a rule may be that vehicles may be parked in a spot for a fixed parking fee for a fixed duration. For example, the parking meter 103 may allow a vehicle to park for 2 hours for fixed fee of $5.00. Thus, no requested parking duration is required because the parking meter 103 permits parking for only 2 hours or less. Parking rules may be applied automatically upon detecting the presence of a vehicle in a parking spot 140. In some embodiments, the vehicle must remain in the parking sport for a predetermined period of time so that the system can infer that the driver intended to park the vehicle.

FIG. 5 is a schematic block diagram that provides one example of a computing device 500 used to implement various embodiments of the present disclosure. The computing device 500 may refer to one or more computing devices with distributed hardware and software to implement the functionality of the computing device. The computing device 500 may implement the method 400 of FIG. 4. In addition, the computing device 500 represent the hardware of the parking meter 103 and/or computing system 101.

The computing device 500 includes at least one processor circuit, for example, having a processor 503 and memory 506, both of which are coupled to a local interface 509 or bus. When implemented in a parking meter 103, the process 503 corresponds to the processor 212 of FIG. 2 and the memory 506 corresponds to the memory 214 of FIG. 2. The local interface 509 may comprise, for example, a data bus with an accompanying address/control bus or other bus structure as can be appreciated.

Stored in the memory 506 are both data and several components that are executable by the processor 503. In particular, stored in the memory 506 and executable by the processor 503 are one or more software programs 517. The software programs may include, for example, a parking application, a payment system, or other software implemented by the computing system 101 and/or parking meter 103. Also stored in the memory 506 may include the data stored in the data store 104.

It is understood that there may be other applications that are stored in the memory 506 and are executable by the processor 503 as can be appreciated. Where any component discussed herein is implemented in the form of software, any one of a number of programming languages may be employed, such as, for example, C, C++, C#, Objective C, Java®, JavaScript®, Perl, PHP, Visual Basic®, Python®, Ruby, or other programming languages.

Several software components are stored in the memory 506 and are executable by the processor 503. In this respect, the term “executable” means a program file that is in a form that can ultimately be run by the processor 503. Examples of executable programs may be, for example, a compiled program that can be translated into machine code in a format that can be loaded into a random access portion of the memory 506 and run by the processor 503, source code that may be expressed in proper format such as object code that is capable of being loaded into a random access portion of the memory 506 and executed by the processor 503, or source code that may be interpreted by another executable program to generate instructions in a random access portion of the memory 506 to be executed by the processor 503, etc. An executable program may be stored in any portion or component of the memory 506 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 506 is defined herein as including both volatile and nonvolatile memory and data storage components. Volatile components are those that do not retain data values upon loss of power. Nonvolatile components are those that retain data upon a loss of power. Thus, the memory 506 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 503 may represent multiple processors 503 and/or multiple processor cores and the memory 506 may represent multiple memories 506 that operate in parallel processing circuits, respectively. In such a case, the local interface 509 may be an appropriate network that facilitates communication between any two of the multiple processors 503, between any processor 503 and any of the memories 506, or between any two of the memories 506, etc. The local interface 509 may couple to additional systems such as the communication interface 145 to coordinate communication with remote systems.

Although components described herein may be embodied in software or code executed by hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc.

The flowcharts discussed above show the functionality and operation of an implementation of components within a system such as a parking meter 103 and/or computing system 101. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system, such as a processor 503 in a computer system or other system. The machine code may be converted from the source code, etc. If embodied in hardware, each block may represent a circuit or a number of interconnected circuits to implement the specified logical function(s).

Although the flowcharts show a specific order of execution, it is understood that the order of execution may differ from that which is depicted. For example, the order of execution of two or more boxes may be scrambled relative to the order shown. Also, two or more boxes shown in succession may be executed concurrently or with partial concurrence. Further, in some embodiments, one or more of the boxes may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The components carrying out the operations of the flowcharts may also comprise software or code that can be embodied in any non-transitory computer-readable medium for use by or in connection with an instruction execution system such as, for example, a processor 503 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any program or application described herein, including software program 517, may be implemented and structured in a variety of ways. For example, one or more applications described may be implemented as modules or components of a single application. Further, one or more applications described herein may be executed in shared or separate computing devices or a combination thereof. Additionally, it is understood that terms such as “application,” “service,” “system,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a processor;
a memory storing a plurality of instructions, which, when executed, cause the processor to:
establish communication with a first sensor configured to detect a presence of a vehicle at a location designated for parking;
receive at least one message from the first sensor, the at least one message indicating the presence of the vehicle;
initiate a first timer in response to receiving the at least one message;
receive signaling that comprises an identifier associated with the vehicle;
determine whether signaling that indicates a requested duration for parking the vehicle in the location designated for parking is received before the first timer expires;
outputting, in response to the first timer expiring before the signaling that indicates the requested duration is received, a first alarm signal;
initiate a second timer in response to receiving the signaling that indicates the requested duration, wherein a duration of the second timer is based at least in part on the requested duration for parking the vehicle;
generate a second alarm signal in response to the at least one message indicating the presence of the vehicle and in response to the second timer expiring.

2. The system of claim 1, further comprising a camera configured to capture an image of a license plate of the vehicle; wherein the identifier is derived from the image of the license plate.

3. The system of claim 1, wherein the plurality of instructions, which, when executed, further cause the processor to establish communication with a mobile device of a user to receive the signaling that indicates the requested duration for parking the vehicle.

4. The system of claim 3, wherein the plurality of instructions, which, when executed, further cause the processor to receive from the mobile device the signaling that comprises the identifier.

5. The system of claim 1, wherein the plurality of instructions, which, when executed, further cause the processor to:
identify contact information associated with a user based on the identifier.
transmit a notification prior to the first timer expiring, wherein the notification is transmitted according to the contact information at predetermined time prior to the first timer expiring.

6. The system of claim 5, wherein the plurality of instructions, which, when executed, further cause the processor to:
register the user by obtaining a license plate number corresponding to the vehicle and the contact information associated with the user;
store a cumulative parking fee balance associated with the user; and
receive a parking fee payment to be applied towards the cumulative parking fee balance.

7. The system of claim 1, wherein the first alarm signal is received by an alarm system to generate an audio or visual alarm.

8. A system, comprising:
a sensor;
a parking meter in communication with the sensor, the parking meter comprising memory and a processor, the processor being configured to:
receive periodic messages from the sensor indicating whether a presence of a vehicle is detected;
determine a duration of the presence of the vehicle based on the periodic messages;
receive signaling that comprises an identifier associated with the vehicle;
initiate a timer in response to receiving signaling that indicates a requested duration for parking the vehicle, the signaling that indicates the requested duration for parking the vehicle comprising a requested parking duration, wherein a timer expiration is set according to the requested parking duration;
outputting a first electronic message in response to the duration exceeding a predetermined threshold and in response to not receiving the signaling that indicates the requested duration for parking the vehicle; and
outputting a second electronic message in response to the periodic messages indicating the presence of the vehicle and in response to the timer expiring.

9. The system of claim 8, wherein the first electronic message and second electronic message are transmitted to a mobile device of a parking attendant.

10. The system of claim 8, wherein the processor is configured to establish communication with a remote server.

11. The system of claim 10, wherein the processor is configured to receive the identifier from the remote server.

12. The system of claim 10, the remote server is configured to:
identify contact information associated with a user based on the identifier.
generate a notification prior to the timer expiring, wherein the notification is transmitted according to the contact information at a predetermined time prior to the timer expiring.

13. The system of claim 10, wherein the server is configured to:
register the user by obtaining a license plate number corresponding to the vehicle and the contact information associated with the user;
store a cumulative parking fee balance associated with the user; and
receive a parking fee payment to be applied towards the cumulative parking fee balance.

14. The system of claim 8, wherein the processor is further configured to generate an alarm signal when generating the first electronic message, wherein the alarm signal is received by an alarm system to generate an audio or visual alarm.

15. A method comprising:
communicating with a sensor installed within or adjacent to a location designated for parking one or more vehicles;
receiving at least one message from the sensor, the at least one message indicating whether a portion of a vehicle is within the location designated for parking;
initiating a first timer in response to receiving the at least one message;
receiving signaling that comprises an identifier associated with the vehicle;
determining whether signaling that indicates a requested duration for parking the vehicle in the location designated for parking is received from the vehicle or another device associated with the vehicle before the first timer expires;
initiating a second timer in response to receiving the signaling that indicates the requested duration, wherein a duration of the second timer is based at least in part on the requested duration for parking the vehicle; and
outputting, in response to an indication that the portion of the vehicle is in the location designated for parking and in response to the second timer expiring, a first alarm signal that comprises the identifier associated with the vehicle; or
outputting in response to the first timer expiring before the signaling indicating the requested duration is received, a second alarm signal.

16. The method of claim 15, wherein a camera is configured to capture an image of a license plate of the vehicle; wherein the identifier is derived from the image of the license plate.

17. The method of claim 15, further comprising receiving the identifier and the parking request from a mobile device.

18. The method of claim 15, further comprising:
identifying contact information associated with a user based on the identifier; and
transmitting a notification prior to the first timer expiring, wherein the notification is transmitted according to the contact information at predetermined time prior to the first timer expiring.

19. The method of claim 15, further comprising
registering a user by obtaining a license plate number corresponding to the vehicle and the contact information associated with the user;
storing a cumulative parking fee balance associated with the user; and
receiving a parking fee payment to be applied towards the cumulative parking fee balance.

20. The method of claim 19, wherein the first alarm signal is received by an alarm system to generate an audio or visual alarm.
